(19) United States
(12) Patent Application Publication
(10) Pub. No.: US 2008/0131864 A1
(43) Pub. Date: Jun. 5, 2008

(54) CURRENCY RATINGS FOR SYNCHRONIZABLE CONTENT

(76) Inventors: Brandt Christian Redd, Provo, UT (US); James Russell Ivie, Lindon, UT (US); Mark Wolfgramm, Provo, UT (US); Brady S. Isom, Pleasant Grove, UT (US); Jeffery R. Gammon, Pleasant Grove, UT (US); Bernd Helzer, Draper, UT (US); Todd J. Hardman, Orem, UT (US); Paul Bryon Smith, Lehi, UT (US); Jiaxin Jerry Gao, Lehi, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/851,350

(22) Filed: Sep. 6, 2007

Related U.S. Application Data
(60) Provisional application No. 60/824,750, filed on Sep. 6, 2006.

(51) Int. Cl. G09B 5/14

(52) U.S. Cl. 434/365

(57) ABSTRACT

A method tracks course materials in a computing environment for online courses. The method includes creating a set of course materials for an educational course. The set of course materials are stored in an educational management system. The set of course materials are posted for users to download through a network connection. The set of course materials are associated with a particular online course. The set of course materials are distributed from the educational management system to a user's computer through the network connection. The use of the set of course materials by a user is tracked to provide tracking information. The tracking information is recorded in the educational management system.

### CROSS-REFERENCE TO RELATED APPLICATIONS

This application claims the benefit of U.S. Provisional Patent Application No. 60/824,750, filed on Sep. 6, 2006, which is hereby incorporated by reference.

### BACKGROUND OF THE INVENTION

1. The Field of the Invention

The invention generally relates to online systems for educational course materials, and more particularly, to currency ratings for content capable of being synchronized.

2. The Relevant Technology

Web-based learning management system (LMS) and content management system (CMS) applications have transformed learning and education within corporations, government agencies and higher education institutions. Employees can take courses on their own time and at their own pace, while management and human resources are able to track progress. Students have access to more relevant content hosted by higher education faculties.

Due to the flexible and individualized nature of the systems, students and employees can take courses on their own time and at their own pace, in accordance with their various daily commitments, while educators, management, and human resource departments are able to track the students' progress. Further, because the systems may be easily updated and modified, the systems often provide more relevant information than is currently available using traditional teaching tools.

One advantage of these courses is the ability to give students key information they need outside the confines of the traditional university buildings or classrooms. The distance learning students can gain access to the course materials by connecting to the Internet or other global network. Thus, several institutions have implemented online or hybrid courses where the course is administered wholly or partially in the online setting.

Online CMS systems have been implemented to enhance online and even hybrid courses. These courses give students key information they need outside the confines of the traditional university buildings. The distance learning students can gain access to the course materials by connecting to the Internet or other global network.

The educational systems are trying to develop a completely individualized or personalized learning environment, wherein students receive instruction that is custom-tailored so that the student is adequately challenged with new and interesting material. This task is difficult, if not impossible, in the traditional classroom setting, where teachers' limited time and attention must be directed to an entire classroom full of students simultaneously. Without better tools to assess and supply students with customized course materials, it is often too difficult for teachers to adequately challenge and guide each student at the appropriate level.

### BRIEF SUMMARY OF THE INVENTION

A method tracks course materials in a computing environment for online courses. The method includes creating a set of course materials for an educational course. The set of course materials are stored in an educational management system. The set of course materials are posted for users to download through a network connection. The set of course materials are associated with a particular online course. The set of course materials are distributed from the educational management system to a user's computer through the network connection. The use of the set of course materials by a user is tracked to provide tracking information. The tracking information is recorded in the educational management system.

In another aspect of the invention, a system tracks course materials in a computing environment for online courses. The system includes a content provider including course materials for an online course to be accessed by a user's computer. The system also includes an educational management system including a server and a database. The educational management system stores the course materials and is configured to post the course materials associated with a particular online course for users to download through a network connection. The educational management system is configured to track the use of the course materials by a user to provide tracking information. The tracking information is stored in the educational management system.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-B are block diagrams illustrating an exemplary system capable of performing the invention;

FIG. 2 is a block diagram illustrating the method of the present invention;

FIGS. 3-4 are block diagram illustrating the method of the invention in a networked computing system;

FIG. 5 is a diagram illustrating the various services available via the distributed access protocol according to one aspect of the invention; and

FIG. 6 is a diagram illustrating examples of the various integrating learning solutions that may be used in association with the invention.

### DETAILED DESCRIPTION OF THE VARIOUS EMBODIMENTS

The principles of the various embodiments are described using the structure and operation of examples to illustrate the present invention. The embodiments provide the capability to track learning objectives for online courses, which are used, for example, in course materials, tests, assignments, quizzes, projects, and the like. The system measures the projected course objectives against the outcome.

Throughout the discussion of this system, the term “user” may be used to describe students, employees, content providers, educators, employers, or course administrators who are accessing the education management system using a computer. The computer may be any specific of general computer system that is equipped to receive, send, and process educational content. The computer may be, for example, a personal computer, or any other computing machine. A suitable computer system may include components such as a modem, monitor, keyboard, mouse, system software including support for TCP/IP communication, and other various types of software. While using the system, more than one user may connect to the education management system using the same computer.

The user's computer connects to the system by providing a user name and password. When the user connects to the system, the user's computer and the educational system perform a syncing operation. During the syncing operation, the educational system receives any work or new data that has been created or modified while the user's computer was offline and the user's computer receives any new information or data available on the educational system.

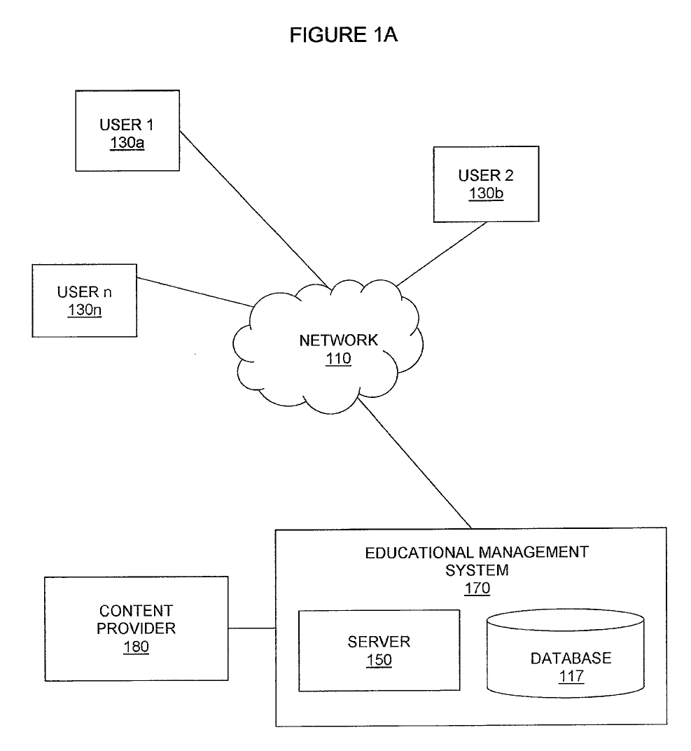

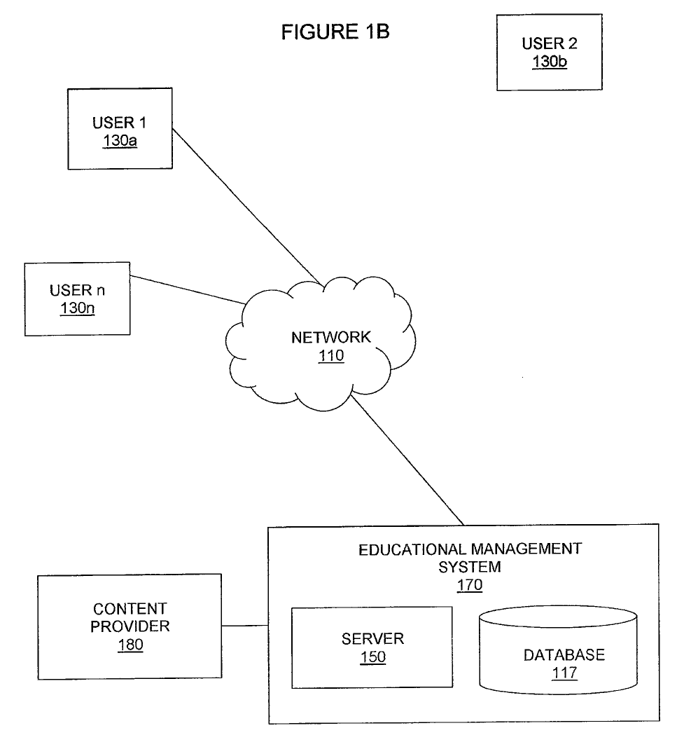

FIG. 1A is a block diagram illustrating an exemplary system capable of performing the present invention. As shown, the system includes a number of users, “User 1” 130a, “User 2” 130b, through “User n” 130n, who are connected to an educational management system 170 via a network connection 120. The network 120 may be any local or global network, including a LAN, wireless network, Internet connection, and the like.

In this embodiment, the education management system 170 includes a server 150 capable of sending and receiving communications and data via the network 120, and a database 160 capable of storing a plurality of educational software and data. In addition, the database 160 can be used to store data relating to the user identification and correlate the user's data to the user identification. As will be understood by one of ordinary skill in the art, any number of configurations may be used to create an education system, including systems using a series of interconnected databases, computers, and servers.

In this example, the education management system 170 is connected to a content provider 180. Here, the content provider 180 may be a third party content provider, who is responsible for creating various course software products to be used in the educational management system 170. Alternatively, the content provider 180 may be part of the education management system 170. Further, the content provider 180 may be an educator or course developer who connects to the education management system 170 as a user.

According to one embodiment of the present invention, the system may use a mechanism such as a bit torrent or related protocol wherein the system may use a peer-to-peer communications protocol to share the educational content. Using such systems, the system typically breaks down any content into a number of smaller, identically-sized pieces, which are distributed among a plurality of users of the system who require the educational content. Then using a series of P2P connections, the files may be sent and received by the users over a period of time. Advantageously, this method of distribution is capable of distributing large amounts of data widely without requiring the content provider 180 or server 150 to incur the large costs of hardware, hosting, and bandwidth resources that would otherwise be required to distribute the educational content. Further, this embodiment would allow the “trickling” of downloads, meaning that in situations where the content to be downloaded is a large file, the system may permit the user to download smaller discrete portions of the content, instead of requiring a constant connection for the duration of the downloading process. The system can regulate the user downloads over a predetermined period. Thus, in situations where a large number of identical files need to be distributed to a number of users of the system, for instance, at the beginning of a semester or session when each student of the program requires the content associated with the course, the present invention may be effectively distributed without overwhelming the education management system 170.

FIG. 1B illustrates the ability of the present invention to be used when a user, here “User 2” 130b is no longer connected to the education management system 170. As described more fully below, one advantage of the present invention is the ability to transfer or distribute software onto “User 2's” 130b computer which enables “User 2” 130b to continue using the educational software when the computer is not connected to the management system 170. The system operates by distributing various learning software onto the user's computer when the user is connected to the system, to allow the user to use the learning software while not being connected to the system. Later, According to the invention, when “User 2” 130b later establishes a connection with the educational management system 170, such as the connection shown in FIG. 1A, the system 170 will perform a syncing operation, wherein it will send and receive data from the “User 2” computer 130b until both the system 170 and the “User 2” 130b have updated information.

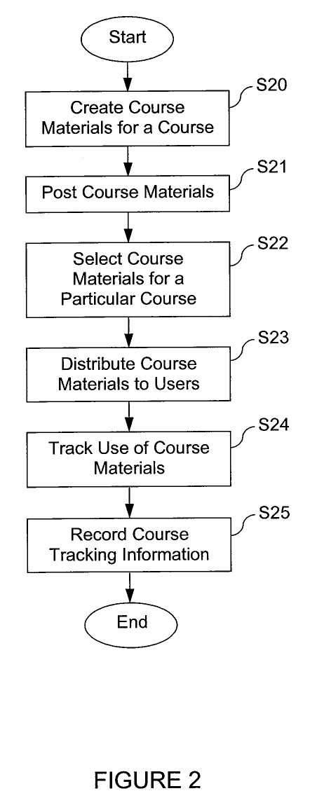

FIG. 2 is a block diagram illustrating a process for performing the present invention in a networked computer environment. At step S20, an author, such as user a through user n, creates course materials for a particular online course. The author can have access to course material shells stored in the educational management system 170 to help build the materials under specified guidelines and format. The course materials can include, for instance, a course assignment, quiz, test, project, and the like. The course materials and shells can be stored in a media container that organizes and links the materials to particular online courses. The course material files are stored in a memory device, such as server 150 on the education management system 170.

In step S21, the course material is then posted on the educational management system 170 to be viewed and distributed by users a through n. The course materials can be distributed to users that are grouped with the particular course through a network connection. The teachers can select previously created or create their own course materials. The teacher in step S22 selects course materials for a particular course. The course materials are distributed through the network 110 to the users that are registered for the particular course in step S23. The materials can be distributed to the users at a select time, for example, after a period of time has passed, at a specified time, once initial registration has been completed, or after a task has been completed, such as an assignment, project, or test.

At step S24 the educational management system 170 tracks the use of course materials. The system can be configured to track the amount of use, i.e. how many times the materials are downloaded by users, accessed by users, selected by a teacher or the like. The system can also be configured to track the location where the materials are downloaded, for example, a remote ISP address, user identification information, user computer information, such as cookies, java, and the like, and other tracking information typically used to identify location. The tracking information in step S25 is recorded and stored in the educational management system using memory, such as server 150.

The course materials can be purchased from content providers or developed to meet particular course objectives. Since purchased materials are very expensive, some teachers end up developing materials for a particular course. The educational system spends much time developing course materials to teach students in an effective manner. It is hard, however, to determine whether the materials are effective.

After materials are developed for an online course, the system provides feedback on the use of the materials. The use allows the author to evaluate how often and where the materials are being used. If the materials are not being used, the materials may be too complex or not very useful. The materials may need to be revised to include additional instruction, to simplify the issues, or replaced with other materials. The tracking system provides the author with feedback to understand how the materials are being used and to modify the materials if needed.

The system can also track the course materials to determine if the materials are current. When the materials are updated, the revised materials are posted to the educational management system. If a user, such as a student or teacher, previously downloaded the materials for a particular course, the system will track the users that downloaded the materials and notify the user that a more current version of the materials is available. The system can prompt the users at a student level and a teacher level. If the user at the student level desires the current version, the materials will automatically download and replace the previously downloaded version when prompted. At the teacher level, if the teacher desires all students to receive the current version of the materials, all the students for the particular course will automatically receive the new version of the materials without being prompted to download. The educational management system can be configured to track how much time users spend viewing or otherwise using a set of course materials.

The educational management system can also track the content currency of the course materials, such as the date the materials were created or updated. Once the materials are posted in the educational management system, the system can date stamp the version. The system can then track the age of the materials. The users can then check the currency of the materials for a particular course.

In scenarios where the user is an educator, course administrator, or content provider, the system enables the users to download course development material, coursework which has been previously submitted by students, discussions, lecture material, grade books, and the like. This enables educators, course developers, and course administrators to grade assignments, quizzes, tests, respond to message boards, and discussion threads while offline. Further, the system enables users to create or author content using an authoring software while offline. When a connection is later established, the user may log into the network and electively upload his or her work into the system.

Distributed learning enables the important components of an e-learning infrastructure to be distributed where and when needed, so that students, faculty, and workers that are not connected to the network can continue their learning and education anytime, anywhere. The users can review for an exam, continue a SCORM-based course, respond to a discussion thread, view a recording of a missed class or grade digitally turned-in assignments without the need for network access. Distributed learning extends the usefulness and scope of the present e-learning systems.

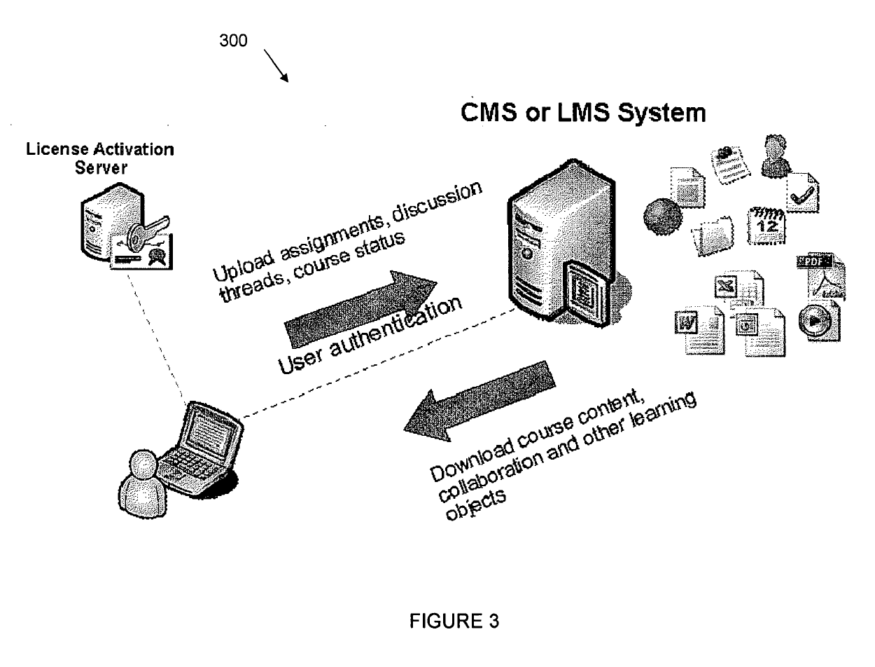

Distributed learning applications provide education institutions, corporations and government agencies with a number of benefits. As shown in FIG. 3, the user logs into the management system, such as CMS or LMS, to upload assignments, course status, or participate in discussion threads. And the user can download course content, collaboration with other users, or other learning objects. The user is not required to be connected to the management system to be able to work on the course materials. For example, the system enhances efficiencies of existing LMS or CMS system to users by expanding usage and minimizing downtime and leverages existing LMS or CMS infrastructure minimizing or eliminating need for changes. Also, it minimizes the need to have a 24/7 infrastructure to support LMS or CMS systems as users carry a copy with them. The system enables mobile workers, troops, faculty and students to be more efficient and effective by leveraging time that is often unproductive. And it allows users to personalize learning content through annotation, organization and digital additions, making their learning more effective.

The present invention includes a platform designed to enable rapid development of partner-branded distributed learning applications. In addition, the system takes learning to a new level by giving students, professionals, and teachers, additional tools to discover, capture, organize, annotate, and search learning content, making it easier to personalize the system to meet the user's individual needs.

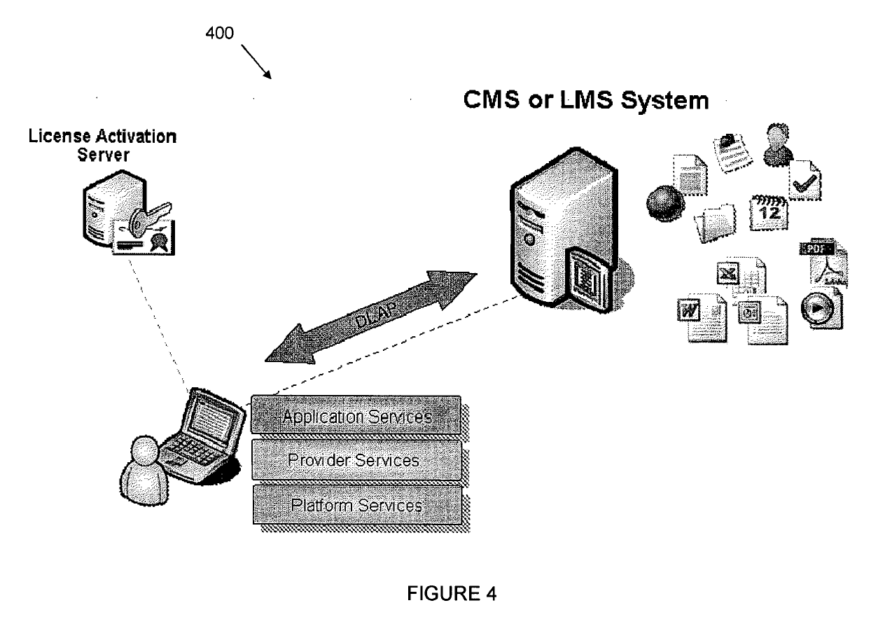

A powerful aspect of the distributed learning platform is the existing suite of components that enable rapid development. The architecture can be divided into four major layers: platform services, provider services, application services, and the distributed learning access protocol (DLAP) as illustrated in FIG. 4.

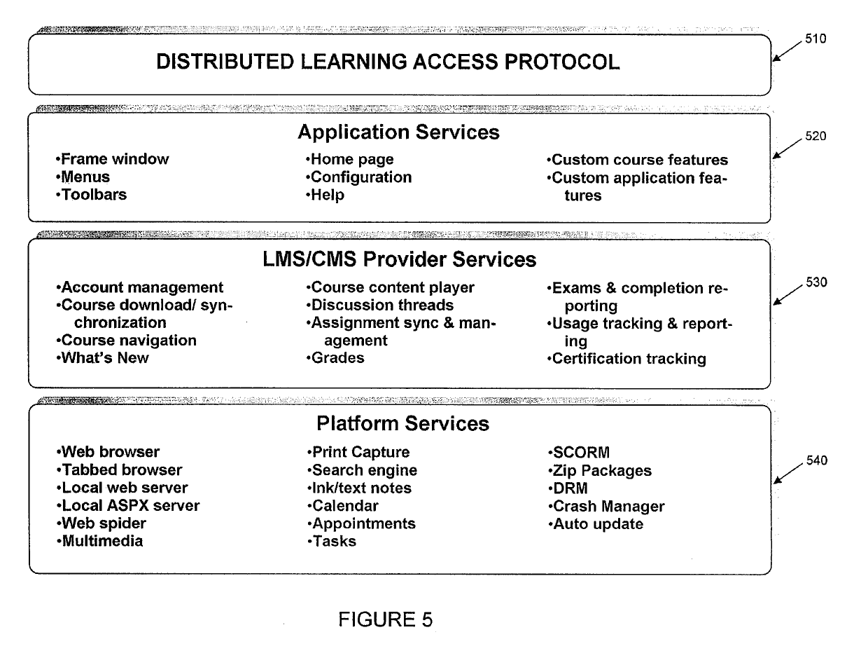

The platform services, as shown in FIGS. 4 and 5, are the core components upon which partner-branded applications are built. One well known component is a .NET ink and text note-taking control. In addition, these services include a web browser built on Internet Explorer controls that enable the application to play any content that works with Internet Explorer, including support for multimedia like Flash, QuickTime, Windows Media, and the like.

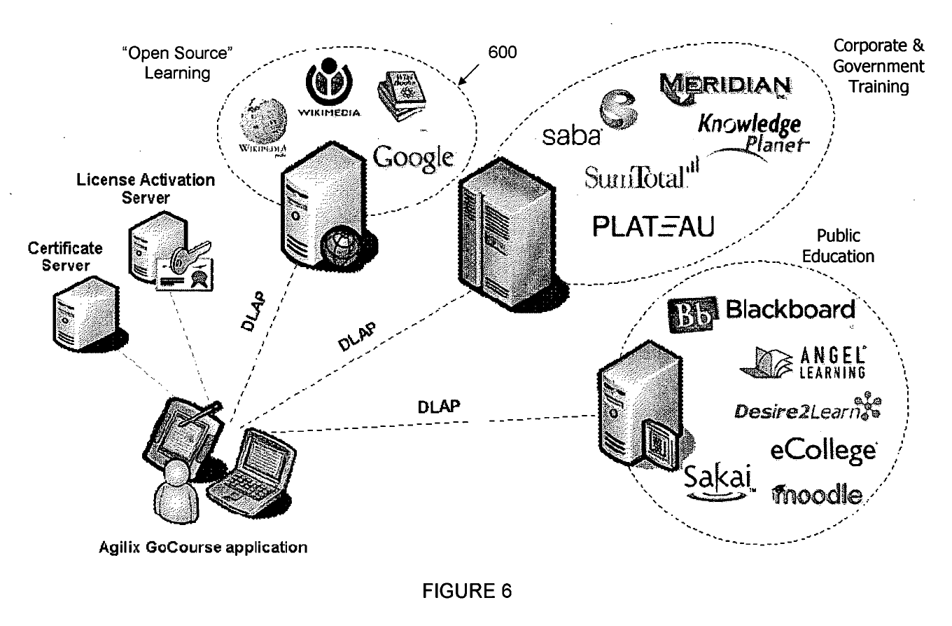

One aspect of the system is to download and upload objects from and/or to the CMS and LMS systems, also illustrated in FIGS. 4 and 6. To support that function, the system has built-in support for common CMS and LMS objects. The support serves can include course content, SCORM learning objects, collaboration, assignments, grades, assessments, and usage activity tracking. Objects can be downloaded or uploaded during any sync session. The application can be set up to support automatic or manual synchronization, with automatic synchronization done on a time-basis or by a specific event. The system also supports connection and user management to maintain links and user account authentication information. The user is authenticated when an identification number or other user identification, such as a user name and password or secure ID, is submitted to the provider and verified against a given account under the provider's license. Support for additional LMS and CMS objects also can be added to the system including a personal learning and research repository, PDF, MS Office, document annotation, digital note-taking, assignment planners, and search programs.

Part of any application branding effort is to create the right look and feel. Application services include the user interface components, such as windows, menus, toolbars, home pages, help, course support, and other custom features. The application services have support for 508 accessibility support. Also included is a configuration tool that makes it easy to create the user-defined options for the application. Custom components can be quickly built to meet unique needs of the partner-branded application.

In order for distributed learning applications to work, a set of APIs are available from the LMS or CMS system as a web service that can deliver high performance to the application built on the system. A web services-based protocol called Distributed Learning Access Protocol (DLAP) can be used between any distributed learning client and any LMS or CMS server. It is designed for very high performance, supports DRM-secure communications, and supports both learner and teacher activities. The system can include the DLAP and the related methods of permitting future third-party online eLearning systems to use defined application program interfaces that will facilitate interoperability and standardization.

A partner-branded application can include all of the key functionality to fit the target user. Some of the application modules are outlined below that can comprise the client. Other examples are illustrated in FIG. 6.

The system supports “round tripping” enabling content to be download or uploaded as necessary. Automatic or manual synchronization, whenever a network connection is available, is supported to keep content current and up-to-date. The course information can be bidirectional and sequential synchronized. This synchronization or “roundtripping” feature updates assignments and assessments. Students can download assignments and assessments to work on them in an environment that is disconnected from the network. The user can also upload results when a connection to the CMS/LMS is established. Furthermore, a user can also download instructor's comments and grades, and resubmit assignments.

The system can also support course development programs, such as an authoring client software product, which enables an author to create educational content. Such programs can enable learning unit authoring, exam editing, HTML editing, rich media support, document attachment, support for ZIP files, and grade book and assignment creators. The program may also provide the author the ability to review the course and the ability to later publish it to the educational management service, during a sync or similar operation.

In another embodiment of the invention, the system can also support a collaborative course authoring environment, where several educators and content providers can work together to develop course content. In one embodiment, the course content may be developed using an educator wiki-style program or similar environment where authorized users may download educational content and later create additional content, edit, remove, or change content, which may be uploaded to the educational server later in order to create course content in a collaborative manner. Advantageously, such a system would enable busy educators to easily and efficiently work together to create educational content.

End user documentation can be developed for the application. Tutorials and flash overviews can be provided to teach end users how to use the application. Training and first line support for the partner can be provided. And the license activation service can be integrated with the partner-branded application.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment for online courses, a method for tracking course materials, the method comprising:
creating a set of course materials for an educational course;
storing the set of course materials in an educational management system;
posting the set of course materials for users to download through a network connection;
associating the set of course materials with a particular online course;
distributing the set of course materials from the educational management system to a user's computer through the network connection;
tracking the use of the set of course materials by a user to provide tracking information; and
recording the tracking information in the educational management system.

2. The method of claim 1, further comprising the step of accessing course material shells to create the course materials, the course material shells being stored in the educational management system.

3. The method of claim 1, further comprising a step of grouping the users by associating the users with a particular online course, wherein the set of course materials is distributed to a group of users.

4. The method of claim 1, wherein the step of distributing the set of course materials further includes distributing the course materials after a preset period of time has passed, at a set time, after the user completes initial registration, or after the user completes a task.

5. The method of claim 1, wherein the step of tracking the use of the set of course materials further includes tracking how many times users download a set of course materials.

6. The method of claim 1, wherein the step of tracking the use of the set of course materials further includes tracking how much time users spend viewing or using the materials.

7. The method of claim 1, wherein the step of tracking the use of the set of course materials further includes tracking how many times users access a set of course materials.

8. The method of claim 1, wherein the step of tracking the use of the set of course materials further includes tracking the location where the user downloads the set of course materials.

9. The method of claim 1, further comprising the step of providing feedback including the tracking information to an author of the set of course materials.

10. The method of claim 1, wherein the step of tracking the use of the set of course materials further includes tracking the currency of the set of course materials.

11. The method of claim 10, further comprising the step of notifying a user that downloaded the set of course materials that a more current version is available if the downloaded materials are outdated.

12. The method of claim 11, wherein the step of notifying the user further includes prompting the user at a student level to automatically download a revised version of the course materials.

13. The method of claim 12, wherein the step of notifying the user further includes prompting the user at a teacher level to automatically download a revised version of the course materials to all users in a particular course.

14. The method of claim 1, wherein the step of tracking the use of the set of course materials further includes date stamping the set of course materials.

15. A system for tracking course materials in a computing environment for online courses, the system comprising:
a content provider including course materials for an online course to be accessed by a user's computer;
an educational management system including a server and a database, the educational management system storing the course materials and being configured to post the course materials associated with a particular online course for users to download through a network connection, the educational management system being configured to track the use of the course materials by a user to provide tracking information, the tracking information being stored in the educational management system.

16. The system of claim 15, further comprising course material shells stored on the educational management system to create the course materials.

17. The system of claim 16, wherein the course material shells are stored in a media container on educational management system that is configured to organize and link the course material shells to particular online courses.

18. The system of claim 15, wherein the educational management system is configured to group the users by associating the users with a particular online course.

19. The system of claim 18, wherein the educational management system is configured to distribute the set of course materials to a group of users.

20. The system of claim 15, wherein the educational management system is configured to track how many times users download a set of course materials.

21. The method of claim 15, wherein the educational management system is configured to track how many times users access a set of course materials.

22. The method of claim 15, wherein the educational management system is configured to track how much time users spend viewing or using a set of course materials.

23. The method of claim 15, wherein the educational management system is configured to track the location where the user downloads the set of course materials.

24. The method of claim 15, wherein the educational management system is configured to track the currency of the set of course materials.
